(19) United States
(12) Patent Application Publication
(10) Pub. No.: US 2006/0003818 A1
(43) Pub. Date: Jan. 5, 2006

(54) Hinge lock

(76) Inventors: Jacob Navntoft, Helsinger (DK); Rasmus Christjansen, Hedebusene (DK); Niels Peter Emme, Copenhagen S (DK); Allan Meller Kristensen, Frederikssund (DK)

Correspondence Address: PERMAN & GREEN, 425 POST ROAD, FAIRFIELD, CT, 06824, US

(21) Appl. No.: 10/881,457

(22) Filed: Jun. 30, 2004

(51) Int. Cl. H04M 1/00

(52) U.S. Cl. 455/575.3

(57) ABSTRACT

A telephone comprises a first housing part (301) and a second housing part, where the first and second housing parts are electrically and mechanically joined via a tilt and swivel hinge. The hinge is configured to allow movement of the first and second housing parts between a plurality of positions relative to each other, and the hinge comprises a tilt shaft (309) and a swivel shaft arranged along a tilt axis (320) and a swivel axis, respectively. The tilt shaft is arranged at least partly within the first housing part (301) and the first housing part is configured to engage with a hinge lock device (340), which is configured to prevent the tilt shaft (309) from moving relative to the first housing part (301) along the tilt axis.

### FIELD OF THE INVENTION

The present invention relates to a telephone device and a hinge unit in a telephone device.

### BACKGROUND

Communication devices have during the last decades evolved from being more or less primitive telephones, capable of conveying only narrow band analog signals such as voice conversations, into the multimedia mobile devices of today capable of conveying large amounts of data representing any kind of media. For example, a telephone in a GSM, GPRS, EDGE, UMTS or CDMA2000 type of system is capable of recording, conveying and displaying both still images and moving images, i.e. video streams, in addition to audio data such as speech or music.

Needless to say, such devices usually require one or more large display screens as well as at least one keypad with input means. Consequently, such devices are often of the folding type having a double housing, i.e. two housing parts joined together with hinge means.

One problem related to such telephones having two main housing parts joined together with, e.g., a tilt and swivel hinge, is that they may tend to be more fragile when subject to rough handling. It is hence important that the hinge is very robust and reliable. A mobile phone is exposed to various mechanical stresses and shocks from e.g. accidental drops and other rough handling. A hinge in a foldable mobile phone is further exposed to friction forces in connection with opening/closing of the phone, which can be many times a day. Still it is expected that the hinge of the phone work properly, during years of use.

At the same time it is necessary that the hinge provides for a user to open and close the foldable parts of the phone in an easy and comfortable manner. The friction in the hinge should not be to high, but has to be just high enough to keep the parts in the preferred open position. As it in general is desired to keep a the size and weight of the mobile phone as low as possible the hinge parts should be as small and light as possible. In order minimize production cost, the hinge parts should designed in order to facilitate automatic assembly.

Prior art hinges in general do not provide all of these necessary characteristics. For example, U.S. Pat. No. 6,148,480 and U.S. Pat. No. 6,633,643 disclose hinge constructions for telephones, without discussing any problems as those stated above.

### SUMMARY OF THE INVENTION

It is hence an object of the present invention to provide a foldable telephone, which is capable of withstanding rough handling. That is, to provide a telephone with a hinge mechanism which does fulfill the above requirements for shock resistance while at the same time being easy to assemble and does not compromise the general requirements of mobile telephones.

The object is achieved by means of a telephone according to claim 1 and a hinge device according to claim 5.

A telephone according to the invention comprises a first housing part and a second housing part, where the first and second housing parts are electrically and mechanically joined via a tilt and swivel hinge. The hinge is configured to allow movement of the first and second housing parts between a plurality of positions relative to each other, and the hinge comprises a tilt shaft and a swivel shaft arranged along a tilt axis and a swivel axis, respectively. The tilt shaft is arranged at least partly within the first housing part and the first housing part is configured to engage with a hinge lock device, which is configured to prevent the tilt shaft from moving relative to the first housing part along the tilt axis.

Preferably, the hinge lock device is a substantially flat C-type washer having a semi circular opening, straddling the tilt shaft and engaged with the tilt shaft via a tilt shaft hinge cap.

The washer comprises, in a preferred embodiment, a finger extending from the washer, where said finger is engaged with a pin extending from the first housing part of the telephone. The pin is preferably made of a material suitable for being melted for locking the washer to the first housing part of the telephone.

An advantage of the present invention is that a telephone nwith such a hinge mechanism solves the problems related to the requirements of shock proofness. Moreover, at the same time assembly is relatively easy and a telephone equipped with a hinge lock device does not compromise the general requirements of multimedia foldable telephones.

### BRIEF DESCRIPTION OF THE DRAWINGS

FIGS. 1a-1c are schematically drawn perspective views of a telephone according to the present invention.

FIG. 2 is a functional block diagram of a telephone according to the present invention.

FIG. 3a is a perspective view from above of a hinge part of a telephone according to the present invention.

FIG. 3b is a perspective view from below of the hinge part depicted in FIG. 3a, showing more details than FIG. 3a.

FIGS. 4a and 4b are perspective views illustrating a hinge lock engaging with a hinge via a hinge cap.

### DETAILED DESCRIPTION OF PREFERRED EMBODIMENTS

In the following a mobile telephone having multimedia communication capabilities will be used to exemplify the present invention. However, it is to be understood that any type of foldable telephone, with or without, e.g., a camera is equally representative.

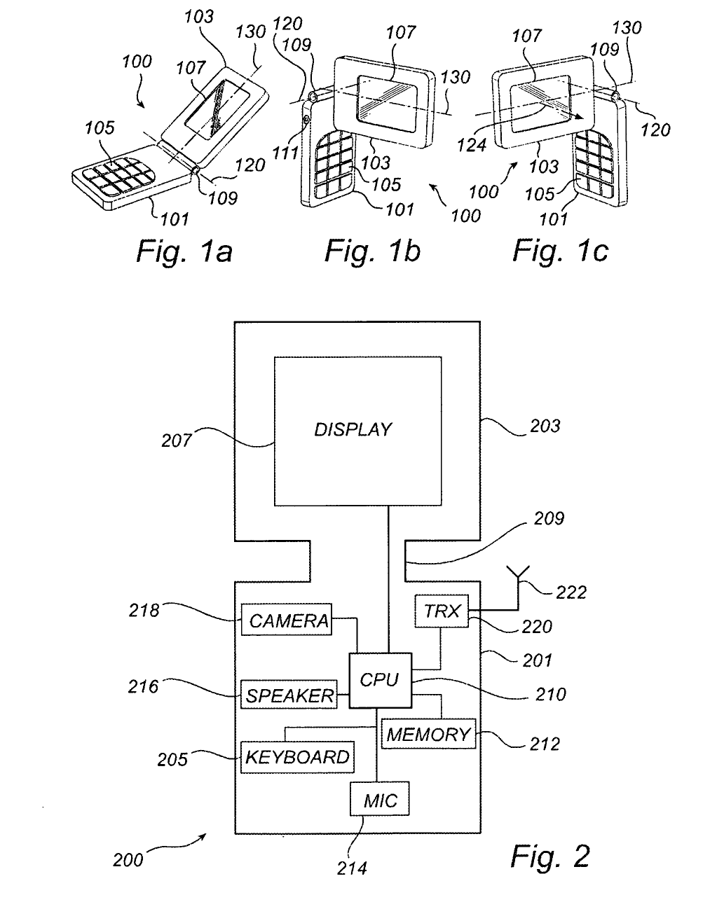

FIGS. 1a, 1b and 1c are three different perspective views of a telephone 100 according to the present invention. The view in FIG. 1a shows the telephone 100 with a first housing part 101 and a second housing part 103. The first housing part 101 comprises a keyboard 105 and the second housing part 103 comprises a display 107. A tilt and swivel hinge 109 connects the two housing parts 101, 103 together and in FIG. 1a the two housing parts 101, 103 are in a position relative to each other where they are slightly tilted with respect to each other around a tilt axis 120. A swivel axis 130, around which the second housing part 103 can swivel, is also indicated in FIG. 1a. The situation illustrated in FIG. 1a is one during which a user of the telephone 100 may manipulate and input information via the keyboard 105 while at the same time viewing output information on the display 107.

The view in FIGS. 1b and 1c show the two housing parts 101, 103 in positions relative to each other, which is different from the relative position shown in FIG. 1a. Moreover, a camera 111 is shown, which is comprised in the first housing part 101. The second housing part 103, with its display 107, is in FIG. 1b tilted around the tilt axis 120 and swiveled around the swivel axis 130, thereby illustrating a first relative position between the housing parts 101, 103. In FIG. 1c, the second housing part 103, with its display 107, is tilted around the tilt axis 120 and swiveled around the swivel axis 130, thereby illustrating a second relative position between the housing parts 101, 103.

FIG. 2 shows a block diagram of a telephone 200 according to the present invention. A first housing part 201 comprises a processing unit 210 connected to an antenna 222 via a transceiver 220, a memory unit 212, a microphone 214, a keyboard 205, a speaker 216 and a camera 218. The processing unit 210 is also connected to a display 207, which is comprised in a second housing part 203 of the telephone 200.

No detailed description will be presented regarding the specific functions of the different blocks of the telephone 200. In short, however, as the person skilled in the art will realize, the processing unit 210 controls the overall function of the functional blocks in that it is capable of receiving input from the keyboard 205, audio information via the microphone 214, images: via the camera 218 and receive suitably encoded and modulated data via the antenna 222 and transceiver 220. The processing unit 210 is also capable of providing output in the form of sound via the speaker 216, images via the display 207 and suitably encoded and modulated data via the transceiver 220 and antenna 222.

The second housing part 203 is mechanically connected to the first housing part 201 via a tilt and swivel hinge 209. The display 207 is electrically connected to the processing unit 210 via electric connection means (not shown in FIG. 2) comprised in the hinge 209.

It is to be noted that the different blocks that have been described above are functional blocks and do not necessarily correspond to actual hardware units in a one-to-one relationship. As the skilled person will realize, functionality comprised in the blocks of FIG. 2 may, wholly or in part, be comprised in one or more integrated circuits in the form of any mixture of programmable and non-programmable circuits.

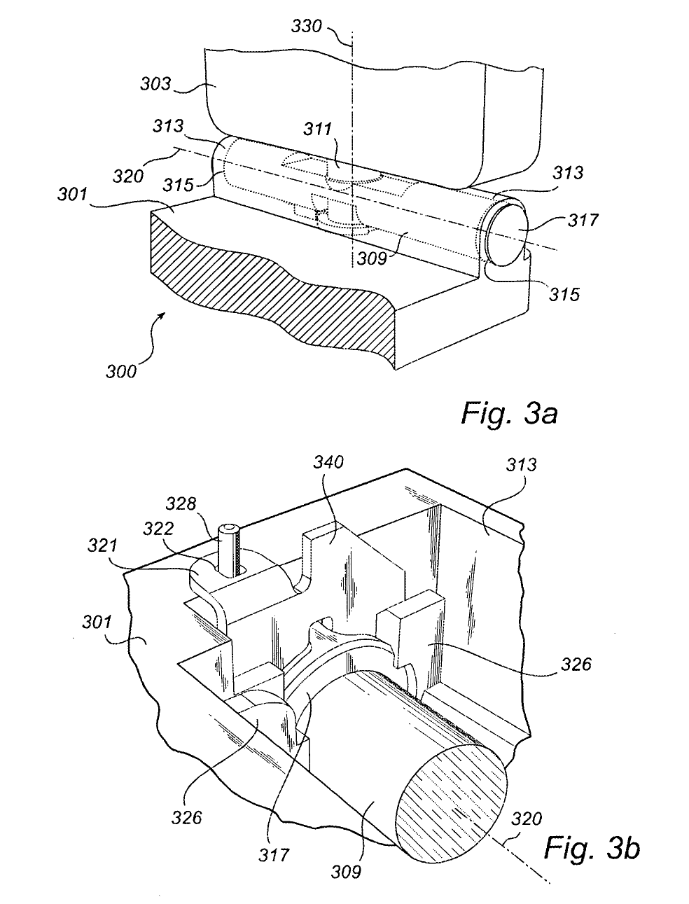

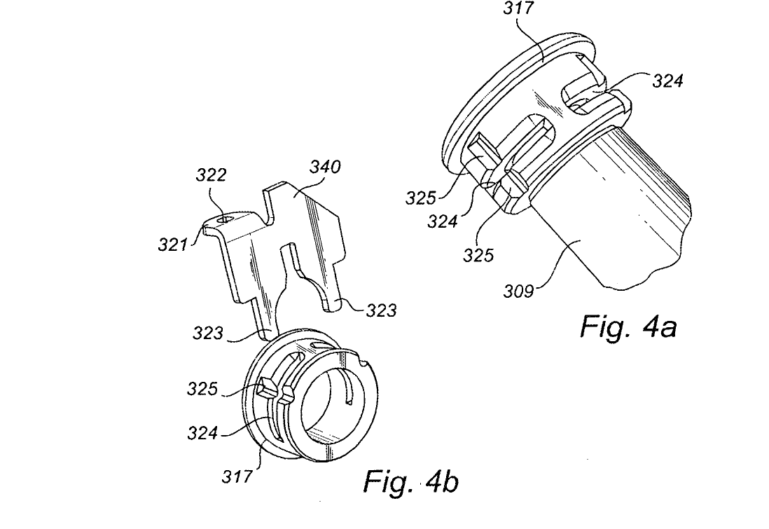

Turning now to FIGS. 3a, 3b, 4a and 4b where a hinge assembly connecting a first housing part 301 and a second housing part 303 of a telephone 300 is shown from two different viewing directions. FIG. 3a is more or less schematically drawn, while FIG. 3b illustrates the hinge assembly in more detail.

The hinge assembly comprises a tilt shaft 309 and a swivel shaft 311 aligned, respectively, along a tilt axis 320 and a swivel axis 330. The tilt shaft 309 is arranged substantially within a recess 313 of the first housing part 301 of the telephone 300, whereas the second housing part 303 of the telephone 300 is attached to a middle section of the tilt shaft 309, to which the swivel axis 311 is connected.

The recess 313 forms a part of the first housing part 301 and has circular openings 315 into which the tilt shaft 309 fits. The tilt shaft 309 is connected to the first housing part 301 via a respective hinge cap 317 (only one hinge cap 317 is shown in FIGS. 3a and 3b).

In order to prevent the tilt shaft 309 from axial movements, due to rough handling such as being dropped from a height and being subject to a mechanical shock when hitting the ground, a hinge lock 340 is used. The hinge lock 340 is preferably in the form of a substantially flat C-type washer having circumference parts 323 defining a semi circular opening. A finger 321 with a hole 322 protrudes at an approximately right angle from the substantially flat washer 340.

The hinge lock 340 is arranged in the recess 313 of the first housing part so that the half circular opening, as defined by the circumference parts 323, fits into a recess 324 of the hinge cap 317, which is fitted onto the tilt shaft 309. Notches 325 in the hinge cap 31.7 engage with protrusions 326 of the first housing part 301 in order to secure the hinge cap 317 in the recess 313. The hole 322 in the finger 321 is fitted onto a plastic pin 328 forming part of the first housing part 301. The plastic pin 328 is preferably melted during the process of installing the hinge lock 340 and thereby rigidly securing the hinge lock 340 to the first housing part 301. Thereby the tilt shaft 309 is prevented from axial movement and the hinge lock 340 is prevented from falling out of the first housing part 301.

1. A telephone (100, 200; 300) comprising a first housing part (101,201,301) and a second housing part (103,203, 303), said first and second housing parts being electrically and mechanically joined via a tilt and swivel hinge configured to allow movement of said first and second housing parts between a plurality of positions relative to each other, said hinge comprising a tilt shaft (309) and a swivel shaft (311) arranged along a tilt axis (320) and a swivel axis (330), respectively, said tilt shaft being arranged at least partly within the first housing part and said first housing part is configured to engage with a hinge lock device (340) configured to prevent said tilt shaft from moving relative to the first housing part along the tilt axis.

2. A telephone according to claim 1, where said hinge lock device is a substantially flat C-type washer having a semi circular opening, said washer straddling the tilt shaft and engaged with the tilt shaft via a tilt shaft hinge cap (317).

3. A telephone according to claim 1, where said washer further comprises a finger (321) extending from the washer, where said finger is engaged with a pin (328) extending from the first housing part of the telephone.

4. A telephone according to claim 3, where said pin is made of a material suitable for being melted for locking the washer to the first housing part of the telephone.

5. Hinge lock device (340) for a telephone (100, 200, 300), said telephone comprising a first housing part (101, 201, 301) and a second housing part (103,203, 303), said first and second housing parts being electrically and mechanically joined via a tilt and swivel hinge configured to allow movement of said first and second housing parts between a plurality of positions relative to each other, said hinge comprising a tilt shaft (309) and a swivel shaft (311) arranged along a tilt axis (320) and a swivel axis (330), respectively, said tilt shaft being arranged at least partly within the first housing part and said first housing part comprising the hinge lock device (340) arranged to prevent said tilt shaft from moving relative to the first housing part along the tilt axis.

6. A hinge lock device according to claim 5, being a substantially flat C-type washer having a semi circular opening, said washer configured to straddle the tilt shaft and engage with the tilt shaft via a tilt shaft hinge cap (317).

7. A hinge lock device according to claim 6, further comprising a finger (321) extending from the washer, where said finger is configured to be engaged with a pin (328) extending from the first housing part of the telephone.
